(19) United States
(12) Patent Application Publication
(10) Pub. No.: US 2010/0321968 A1
(43) Pub. Date: Dec. 23, 2010

(54) LOAD FAULT HANDLING FOR SWITCHED RELUCTANCE OR INDUCTION TYPE MACHINES

(75) Inventors: Stephen R. Jones, Winnebago, IL (US); Charles Romenesko, Roscoe, IL (US)

Correspondence Address: Cantor Colburn LLP - Hamilton Sundstrand, 20 Church Street, 22nd Floor, Hartford, CT, 06103, US

(73) Assignee: HAMILTON SUNDSTRAND CORPORATION, Windsor Locks, CT (US)

(21) Appl. No.: 12/487,190

(22) Filed: Jun. 18, 2009

(51) Int. Cl. H02M 7/217

(52) U.S. Cl. 363/127

(57) ABSTRACT

An electrical power generation system includes a power source (102) and power conversion electronics (104) coupled to the power source to rectify phased currents received from the power source and maintain a power conversion voltage used to provide excitation to the power source. The system also includes a power conditioner (108) coupled between the power conversion electronics and a load (108), the power conditioner operating as a filter in a normal operational mode and as a buck converter in an abnormal operational mode.

### BACKGROUND OF THE INVENTION

The subject matter disclosed herein relates to electrical power generators and, in particular, to operating switched reluctance machines or induction machines in the event of a load fault.

Switched reluctance and induction machine based systems that include an electrical machine and associated bi-directional power conversion electronics are capable of operation as four-quadrant motor drives. In typical applications the system will be connected to an electrical supply and a mechanical load.

During motoring, power flows from the electrical supply to the mechanical load. During regenerative braking, power flows from the load to the electrical supply. The electrical supply is energized at all times and provides the excitation energy for the electrical machine. Both the switched reluctance machine and the induction machine require excitation at all times. The excitation energy circulates through the same electrical feeders that carry the real power flow between the power converter and the electrical machine.

One application of switched reluctance and induction machine based systems is electrical power generation. In such an application, a prime mover initially rotates the electrical machine. Due to the rotation of the electrical machine, power flows from the prime mover, through the electrical machine and power conversion electronics, to the electrical load. The controlled variable is the voltage to the electrical load at the point of regulation (POR).

In an aircraft application, and in some industrial applications, the electrical power generation system provides dc power, for example 270 Vdc. In prior systems the electrical loads are connected to the dc power conversion of the power conversion electronics through a power quality filter. In steady-state operation, excitation energy for the electrical machine is stored in the dc power conversion capacitors and circulates between the machine and these capacitors.

Initial excitation must be provided by an external supply. Once steady-state operation is achieved, the external supply can be disconnected. In an aircraft application the prime mover is usually a main engine. That engine must be provided with a starter. The generator can provide the start function, if it has sufficient capacity. A large engine will require a significant amount of power to start, more than can be provided by batteries. The electrical power supply for engine start is then typically an auxiliary power unit (APU), an external ground cart, or another engine. These sources are disconnected once the engine has started.

At issue is the ability of the system, when in electrical power generation mode, to remain excited in the event of a load fault. A load fault may draw excess current that, in a system where the loads are connected directly to the dc power conversion through a power quality filter, would be supplied by the dc power conversion capacitors. In turn the dc power conversion voltage will begin to decay and the source of machine excitation will be reduced. An extreme case of a load fault is a direct short circuit across the power conversion electronics output. Electrical system requirements may require that the power generation system continue to source energy in the event of such faults. Hence, a means to continue excitation of the machine, in the event of load faults, must be provided.

One prior approach to maintaining excitation in the event of a fault is to include a permanent magnet generator (PMG) in the power generation system. The system architecture would be configured to allow the PMG to feed excitation energy to the electrical machine, or to supply fault current to the loads. The capacity of the PMG may be a significant percentage of that of the main generator, thus impacting overall system size and weight. In addition, there may be other drawbacks to the use of a PMG. For example, if another electrical machine that has to be driven by the prime mover or an extra pad may have to be provided on the engine gearbox. For an integral starter/generator (ISG) system embedded in the engine, in addition to space for the starter/generator, space has to be allocated within the engine for the PMG. Also, the issue of handling electrical faults within the PMG itself has to be addressed.

### BRIEF DESCRIPTION OF THE INVENTION

According to one aspect of the invention, an electrical power generation system is provided. The system of this embodiment includes a power source and power conversion electronics coupled to the power source to rectify phased currents received from the power source and maintain a power conversion voltage used to provide excitation to the power source. The system of this embodiment also includes a power conditioner coupled between the power conversion electronics and a load, the power conditioner operating as a filter in a normal operational mode and as a buck converter is an abnormal operational mode.

According to one aspect of the invention, a method of operating a system including a power source, power conversion electronics coupled to the power source, and a power conditioner coupled between the power conversion electronics and a load is provided. The method of this embodiment includes operating in a first operating mode with the power conditioner operating as pi filter; determining that a load fault exists at the load; and switching to a second operating mode with the power conditioner operating as a buck converter in the event that a load fault exists.

These and other features will become more apparent from the following description taken in conjunction with the drawings.

### BRIEF DESCRIPTION OF THE DRAWINGS

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is a block diagram showing one embodiment of the present invention; and

FIG. 2 is a circuit diagram showing one embodiment of the present invention.

The detailed description explains embodiments of the invention, together with advantages and features, by way of example with reference to the drawings.

### DETAILED DESCRIPTION OF THE INVENTION

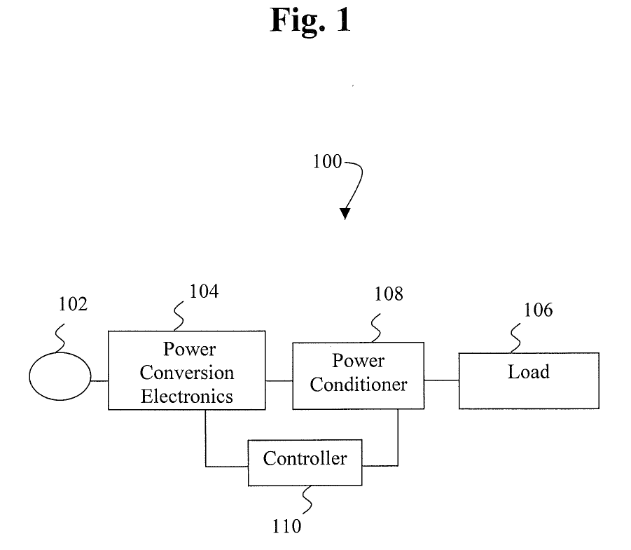

FIG. 1 shows an example of system 100 according to one embodiment of the present invention. The system 100 includes a power source 102. In one embodiment, the power source 102 may be an induction machine. In another embodiment, the power source 102 may be switched reluctance machine. Regardless, the power source 102 may initially require an APU (not shown) to start the power source 102. The power source 102 may include any number of phases.

The system 100 may also include power conversion electronics 104. The power conversion electronics 104 serve a dual purpose. First, the power conversion electronics 104 convert the output of the power source 102 into a direct-current (DC) power output. Second, the power conversion electronics 104 include a component (typically a capacitor) for storing excitation energy for the continued excitation of the power source and, thus, obviating the need for an APU after the power source 102 has been started. In the case where the power supply 102 is an induction machine, the power conversion electronics 104 may include an excitation inverter having two transistors per phase of the induction machine. In the case were the power supply 102 is a switched reluctance machine, the power conversion electronics 104 may include an asymmetric half bridge converter. Regardless, the output of the power conversion electronics 104 may include a capacitor (C1) across its output. This capacitor serves to store energy to maintain the excitation of the power supply 102.

The system 100 may, as in the prior art, also include a load 106. Power is delivered from the power source 102 to the load. In normal operation, the power conversion electronics 104 maintain excitation on the power source 102 as the power is delivered to the load 106. However, in some instances, a load fault, such as a short may exist. In such an instance, the power stored in the power conversion electronics 104 for excitation of the power supply 102 will eventually decay, and possibly disappear, to such a point that it cannot effectively provide excitation to the power supply 102.

To avoid such a situation, embodiments of the present invention may include a power conditioner 108 coupled between the power conversion electronics 104 and the load 106. The power conditioner 108 may include components that allow it to operate as a power filter in normal operation and as a current regulated buck converter in the event of a load fault. In the event of a load fault, the power conditioner 108 operates to ensure that the power conversion electronics 104 may still provide excitation energy to the power supply 102.

The system 100 may also include a controller 110 coupled to both the power conversion electronics 104 and the power conditioner 108. The controller 110, in one embodiment, monitors the conditions of certain electrical components in the power conversion electronics 104 and causes the power conversion electronics 104 and the power conditioner 108 to operate in a particular manner to ensure that excitation energy to the power supply 102 does not fall too low. In normal operation (i.e., operation without a load fault) the controller 110 may cause the power conditioner 108, in combination with the capacitor C1, to operate as a CLC pi-filter. In the event of a load fault, the controller 110 may cause the power conditioner 108 to operate as a current regulated buck converter.

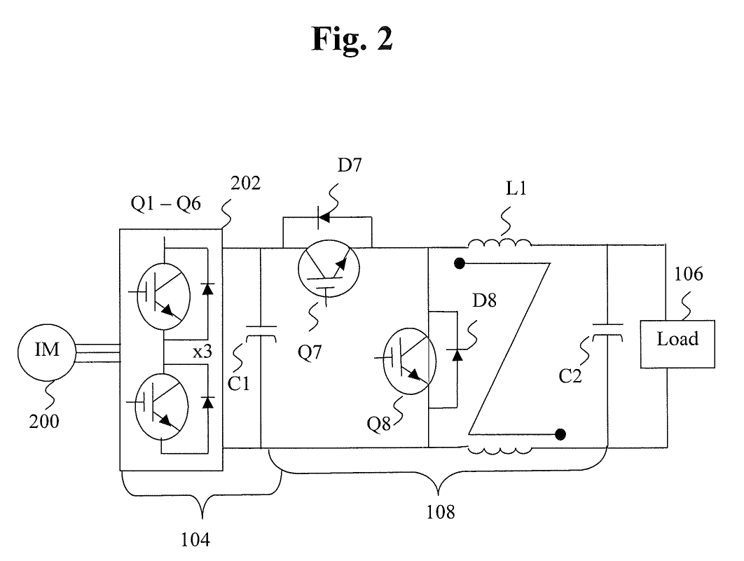

FIG. 2 shows an example of circuit including a three-phase induction machine 200 according to one embodiment of the present invention. Of course, the number of phases need not be three and the machine 200 could have any number of phases.

The induction machine 200 is coupled to a standard excitation converter 202 as known in the prior art. As the excitation converter 202 is three-phase in this example, the excitation converter 202 includes six transistors Q1-Q6, two each serially connected to a particular phase of the induction machine 200. Of course, each transistor may include a diode coupled across its collector and emitter. The excitation converter 202 may include an output capacitor C1 coupled across its output. The excitation converter 202 and the output capacitor C1 form the power conversion electronics 104. As discussed above, the output capacitor C1 is used to provide excitation energy to the induction machine 200.

In one embodiment, the power conditioner 108 is coupled in parallel with the output capacitor C1. In one embodiment, the power conditioner 108 includes two transistors Q7 and Q8, an inductor L1 and a second capacitor C2. The collector of transistor Q7 is coupled to the output of the power conversion electronics 104. The emitter of Q7 is coupled to the collector of Q8 which has its emitter coupled to ground. The emitter of Q7 is also coupled to one end of inductor L1. As shown, inductor L1 has windings on both positive and negative sides. Of course, all of the windings could be on the positive side of the circuit. The other end of the inductor L1 is coupled to load 106, and is also coupled to the second capacitor C2 which is coupled across the load 106.

The base of all of the transistors Q1-Q8 may be coupled to the controller (not shown). The controller may also be coupled such that it may either make or receive measurements of conditions on C1, C2 and L1.

As an example, the circuit shown in FIG. 2 could be used to provide 270Vdc power to aircraft electrical loads. The induction machine 200 would be placed either on a gearbox pad, or internal to the engine on the high or low spool shaft. It could operate with a varying speed range. The excitation converter 202 provides phase voltages to excite the IM and also rectify the phase currents to provide DC-power conversion voltage on output capacitor C1. In one embodiment, the phase currents, the voltage of both capacitors C1 and C1, and the current through inductor L1 are measured. The voltage on C1 is regulated to 270 Volts with the induction machine 200 and appropriate control of the inverter 202. The remaining components (Q7, Q8, L1 and C2) have two different modes of operation: normal and abnormal.

During normal operation Q7 is held on, Q8 is held off, and C1, Q7, L1 and C2 form a CLC pi-filter designed to meet MIL-STD-704E power requirements. The voltage on C2 is the controlled parameter in the voltage regulator algorithm. The size of C1, L1 and C2 are driven by the bandwidth the controller 110 can achieve. A slow controller will not respond quickly to a 100% electrical load transient, so the passive components must store enough energy to ride through the load transient. Conversely, a high bandwidth controller does not need large passive energy storage elements.

Abnormal operation occurs in the event of an electrical load fault, such as the extreme case of a short circuit. During abnormal operation, the voltage on C1 must be regulated so that the fault condition does not allow the voltage to be pulled down such that the induction machine 200, or alternatively switched reluctance machine, becomes de-excited. No power could then be drawn from the machine.

During the abnormal operating scenario, Q7, Q8 and L1 are used as a current regulated buck converter. The current level of L1 is chosen to maintain a constant power output load on C1, the inverter 104, and the induction machine 200. In operation, the buck regulator allows the voltage on C2 to drop, but maintains the voltage on C1 to excite the induction machine. This may be accomplished by opening and closing Q7 in such a manner (via the controller) that C1 does not fall. In one embodiment, Q8 may be replaced with a diode or omitted. Of course, an active device with lower losses than the diode could be used. Switching of Q7 and Q8 would have to guarantee that both were not turned on at the same time. In a low-power converter it is possible that a MOSFET could be found that would have lower losses than the diode. In a high-power application it is more probable that the diode would have lower losses than Q8.

If power flow is required in the reverse direction—from some other source on the 270 Vdc bus to the induction or switched reluctane machine—for example if the electrical machine were to be used as a starter, then L1, Q8, and the diode D7 across Q7 can be used as a boost converter. Q7 would remain turned off when the circuit is operated as a boost converter. Having boost converter capability has the advantage that the voltage across C1 is higher than the voltage across C2. Thus the voltage at the electrical machine can remain more optimum even if power is supplied from a battery whose voltage begins to sag. The use of the buck regulator/boost converter obviates the need for the PMG.

In some circumstances it may be advantageous to initially limit output current by allowing the voltage on C1 to decay to a minimum sufficient to maintain excitation. In this mode, Q7 is not chopping. When the minimum voltage is reached, Q7 will begin chopping in order to regulate the output current.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. An electrical power generation system comprising:
a power source (102);
power conversion electronics (104) coupled to the power source to rectify phased currents received from the power source and maintain a power conversion voltage used to provide excitation to the power source; and
a power conditioner (108) coupled between the power conversion electronics and a load (106), the power conditioner operating as a filter in a normal operational mode and as a buck converter in an abnormal operational mode.

2. The system of claim 1, wherein the power source is an induction machine.

3. The system of claim 2, wherein the power conversion electronics include:
an excitation inverter (202) coupled to the induction machine; and
an output capacitor (C1) coupled to an output of the excitation inverter.

4. The system of claim 1, wherein the power source is switched reluctance machine.

5. The system of claim 4, wherein the power conversion electronics include:
an asymmetric half bridge converter coupled to the switched reluctance machine; and
an output capacitor coupled to an output of the half bridge converter.

6. The system of claim 1, wherein the power conditioner includes:
a first transistor (Q7) including a collector coupled to an output of the power conversion electronics;
an inductor (L1) having a first terminal coupled to an emitter of the first transistor; and
a second capacitor (C2) coupled between a second terminal of the inductor and ground.

7. The system of claim 6, wherein the inductor includes windings on both a positive terminal and a negative terminal.

8. The system of claim 6, wherein in the normal operation mode the first transistor allows current to flow from the output of the power conversion electronics to the inductor and in the abnormal operational mode the first transistor disallows current flow for at least a portion of an operating time of the abnormal operational mode.

9. The system of claim 8, wherein the first transistor is repeatedly switched from an open state to a closed state during the operation time of the abnormal operational mode.

10. The system of claim 1, further comprising:
the load (106).

11. The system of claim 1, further comprising:
a controller (110) coupled to the power conversion electronics and the power conditioner.

12. The system of claim 11, wherein the controller receives inputs containing parameters related to a first capacitor contained in the power conversion electronics, the inductor, and a second capacitor coupled in parallel with the load.

13. The system of claim 1, wherein the system is coupled to a prime mover.

14. The system of claim 1, wherein the system is coupled to an airplane.

15. The system of claim 1, wherein the power conditioner operates in the abnormal operational mode in the event of a short in the load.

16. A method of operating a system including a power source, power conversion electronics (104) coupled to the power source (102), and a power conditioner (108) coupled between the power conversion electronics and a load (106), the method comprising:
operating in a first operating mode with the power conditioner operating as pi filter;
determining that a load fault exist at the load; and
switching to a second operating mode with the power conditioner operating as a buck converter in the event that a load fault exists.

17. The method of claim 16, wherein the second operating mode includes selectively opening and closing a switch (Q7) contained in the power conditioner.

18. The method of claim 17, wherein the switch is opened and closed based on at least a voltage of an output capacitor (C1) contained in the power conversion electronics.

19. The method of claim 18, wherein the switch is a transistor.

20. The method of claim 16, wherein the power source is either an induction machine or a switched reluctance machine.
